(19) United States
(12) Patent Application Publication
(10) Pub. No.: US 2010/0197508 A1
(43) Pub. Date: Aug. 5, 2010

(54) Integrated Universal Chemical Detector with Selective Diffraction Array

(75) Inventors: Dustin S. Carter, Galax, VA (US); Yeonjoon Park, Yorktown, VA (US); Glen C. King, Yorktown, VA (US); Sang H. Choi, Yorktown, VA (US)

Correspondence Address: NATIONAL AERONAUTICS AND SPACE ADMINISTRATION;LANGLEY RESEARCH CENTER, MAIL STOP 141, HAMPTON, VA, 23681-2199, US

(73) Assignee: The Administrator of the National Aeronautics and Space Administration, United States of America, Washington, DC (US)

(21) Appl. No.: 12/364,777

(22) Filed: Feb. 3, 2009

(51) Int. Cl. C40B 30/00; C40B 60/10

(52) U.S. Cl. 506/7; 506/38

(57) ABSTRACT

Integrated universal chemical detector in a micro-optical chip in which chemical/bio-sensitive micro/nano-pixels are aligned to create diffraction patterns that can be visually or instrumentally categorized in order to identify a substantial plurality of agents. By using a diffraction method to create a macroscopic diffraction image, a single small array can effectively detect hundreds or even thousands of different chemicals. The apparatus can be further automated by analyzing the diffraction patterns electronically.

### ORIGIN OF THE INVENTION

The invention was made in part by employees of the United States Government and may be manufactured and used by or for the Government of the United States of America for governmental purposes without the payment of any royalties thereon or therefor.

### BACKGROUND OF THE INVENTION

1. Field of the Invention

The present invention is in the fields of environmental science, analytical chemistry, optics and nanotechnology, and more particularly concerns compact, integrated apparatus for detecting a plurality of chemicals, for example, in the environment, using an optical diffraction array.

2. Description of the Related Art

Apparatus for detecting a plurality of chemicals, for example, in the environment of the detector, have a variety of practical applications, including:
Biotoxin detectors for food processing industries
Biomedical services
Homeland Security
Environmental Protection
Chemical processing units
   To be most practical, such units must be able to detect a sufficiently broad range of chemicals to address the majority of contamination risks in the field of concern, provide quick, clear indication of chemical contamination, yet at the same time be reasonably compact and preferably relatively efficient, easy to use, and inexpensive. (Unless otherwise specified, the terms “chemical” and “agent” as used herein are each intended to encompass both particular species and classes of chemicals as well as bioelements.)

Conventional optical indicators to detect species of chemicals or bio-elements work by providing elements that change colors upon a reaction with the contaminant. Such indicators face challenges to reduce the size of the system while increasing or simply maintaining its detection resolution. In systems having optical indicators, the pixel size of the indicators must generally be large enough in order to be visible, and consequently the integration of many indicators in a small area is difficult. For high resolution sensitivity, the pixel size must be small within an array, while their responsiveness must be high enough to provide clear signals. Further miniaturization of these sensors must address these issues.

Also under widespread current development are new families of “lab-on-a-Chip” (LOC) devices, a subset of “Microelectromechanical Systems” (MEMS) devices that integrate one or several laboratory functions onto a single chip, often with microfluidics, to perform vastly scaled down chemical analyses or analytic procedures such as chromatography. However, there is no standardized type of chemical analysis that broadly characterizes this class of devices. In addition, the detection principles employed in these devices may not always scale down in a positive way, leading to low signal to noise ratios, which would be a significant issue if numerous analyses were to be combined in one small LOC device.

### SUMMARY OF THE INVENTION

It is an object of the invention to provide an integrated broad-range optically-based detector for a plurality of chemicals that overcomes spatial limitations resulting from the individual detector size.

It is a further object of the invention to provide an integrated universal chemical detector in a micro-optical chip in which chemical/bio-sensitive micro/nano-pixels are aligned to create diffraction patterns that can be visually or instrumentally categorized in order to identify a substantial plurality of agents.

To achieve these objectives, the present invention, in one embodiment, provides a programmed array of sets of small chemical indicators in periodic formation that change an optical characteristic, such as color, reflectivity, transmittivity, or refractive index, in a determined manner upon exposure to a specific species or class of chemicals or bioelements. Each detector pixel can be very small in size, preferably only a few micrometers in length, so that tens or hundreds (or more) of different chemical indicators can be integrated into a very small area. Each pixel changes an optical characteristic such as reflectivity, refractive index, or transmittivity upon a reaction with a specific species or class of chemical or bioelement, and each array of all pixels in the responsive set of like pixels creates a different pattern as a result. The pixels can be illuminated by a laser beam to create distinctive diffraction patterns, of a size large enough to be easily seen and categorized, that are characteristic of the pattern (or patterns) of indicators that was activated. In this manner, a single small array can effectively be used to detect hundreds or even thousands of different chemicals. The apparatus can be further automated by analyzing the diffraction patterns electronically.

Other aspects and advantages of the invention will be apparent from the accompanying drawings, and the detailed description that follows.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 schematically shows a diffraction pixel array before (FIG. 1A) and after (FIG. 1B) a chemical reaction.

FIG. 2 schematically shows (FIG. 2A) an array of pixels (fixed reflector+chemical detector), and (FIG. 2B) simulation of the array after a chemical reaction in which chemical detector pixels are darkened.

FIG. 3 is a perspective view of an exemplary optical measurement apparatus in accordance with the invention.

FIG. 4 shows (FIG. 4A) an exemplary diffraction pattern before chemical reaction, and (FIG. 4B) a diffraction pattern after chemical reaction in which every other row in the detector array is darkened.

FIG. 5 shows (FIG. 5A) an exemplary diffraction pattern obtained by alternating transparent refractive pixels (PMMA refractive index n=1.4˜1.5), and (FIG. 5B) an exemplary diffraction pattern produced when the refractive index of alternating pixels becomes close to n=1.

FIG. 6 shows an example of four different coated arrays, showing four different image patterns.

FIG. 7 shows an exemplary layout of detectors on a 1 mm×1 mm array that can detect 2,500 chemicals simultaneously.

FIG. 8 is a sketch of an exemplary device structure providing a probe illuminated by a laser and a CCD counter of diffraction pattern images, which can be used to provide automated identification of detected chemicals.

### DETAILED DESCRIPTION OF PREFERRED EMBODIMENTS

The following is a detailed description of certain embodiments of the invention chosen to provide illustrative examples of how it may preferably be implemented. The scope of the invention is not limited to the specific embodiments described, nor is it limited by any specific implementation, composition, embodiment or characterization depicted in the accompanying drawings or stated or described in the invention summary or the abstract. In addition, it should be noted that this disclosure describes a number of methods that each comprise a plurality of steps. Nothing contained in this written description should be understood to imply any necessary order of steps in such methods, other than as specified by express claim language.

In one embodiment, the invention provides a programmed array of sets of small chemical indicators in periodic formation that change an optical characteristic, such as color, reflectivity, transmittivity, or refractive index, in a determined manner upon exposure to a specific chemical species or class of chemicals or bioelements. Each pixel size is very small, preferably only a few micrometers in length, so that tens or hundreds (or more) of different chemical indicators can be integrated into a very small area. Each pixel changes reflectivity, refractive index, or transmittivity upon a reaction with a specific chemical species and bioelement only, and each array of all pixels in the responsive set of like pixels creates a different pattern as a result.

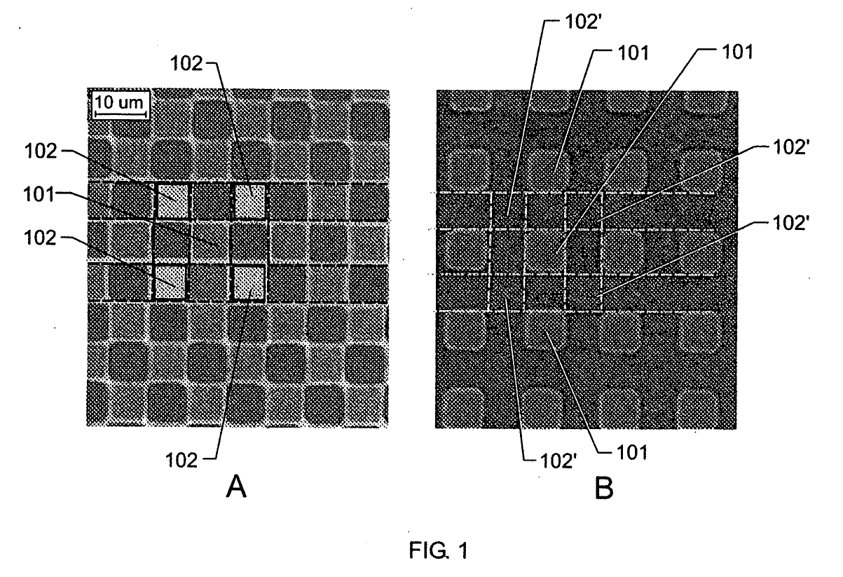

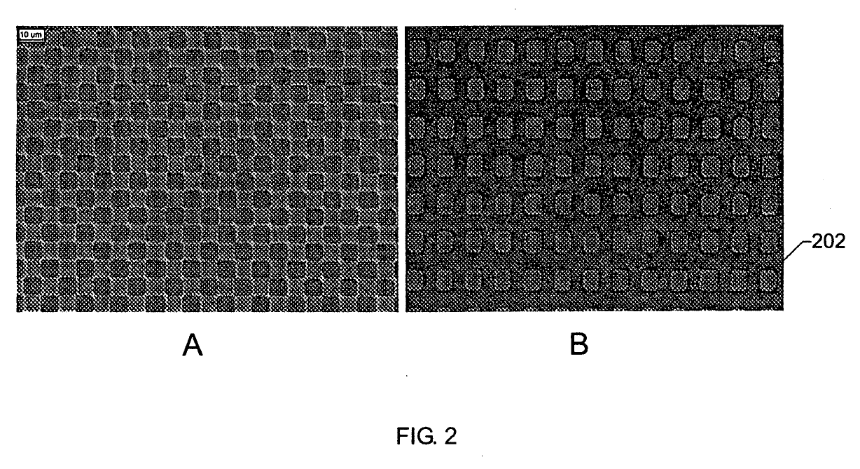

One example of such an array is shown in FIG. 1, constructed on a polymethylmethacrylate (PMMA) thin film. A fixed reflector pixel 101 is surrounded by four chemical detector pixels 102 at the corners as shown in FIG. 1A. When a chemical reaction occurs the chemical detector pixels become dark and drop the reflectivity as shown (see elements 102′) in FIG. 1B. One of such examples is iodine's reaction to starch, in which iodine containing pixel becomes blue/black-colored when exposed to starch. Numerous other reactions producing characteristic optical indications are known to those skilled in the art and may be similarly employed to provide suitable detector elements. In FIG. 1, the change of reflectivity was simulated with e-beam lithography and etching process such that the four surrounding chemical detector pixels are darkened. The result is that every other row of pixels 202 are darkened as shown in FIG. 2B.

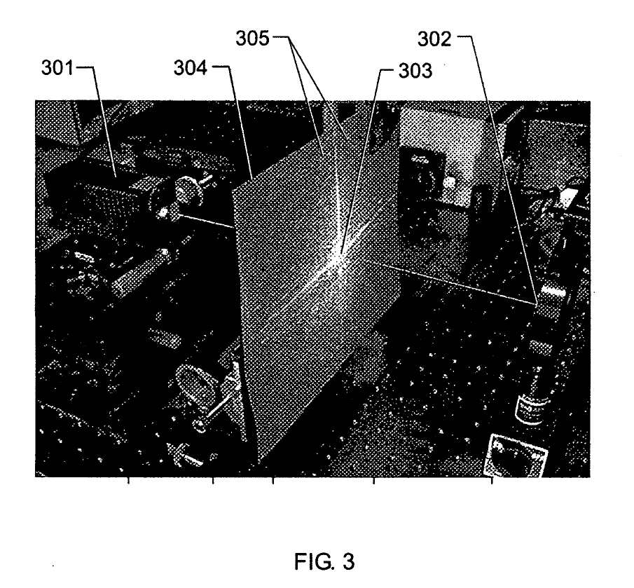

A laser or semi-coherent light source can be used to read out the result of chemical reactions on the multiple pixels from the integrated universal chemical detector chip as shown in FIG. 3. A laser 301 is illuminated vertically on the universal chemical detector chip 302 through a tiny aperture 303 on a white paper screen 304. The diffracted beam patterns 305 are collected on the screen 304. The universal chemical detector can contain multiple types of chemical detectors in sets, in which each set is specially aligned to create different diffraction patterns. Since each pixel is very small, tens or hundreds (or more) of chemical detectors can be integrated in a chip whose size is less than a few centimeters by a few centimeters.

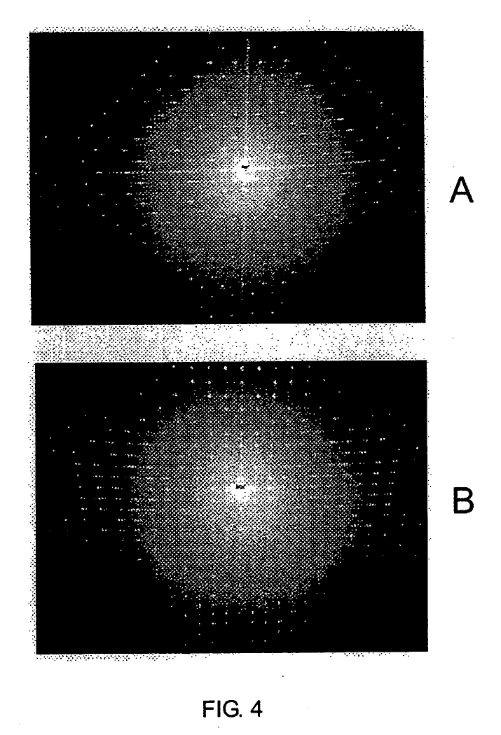

FIG. 4 shows the resulting diffraction patterns from simulated pixels in FIG. 1 and FIG. 2 before and after chemical reaction. The results shown in FIG. 4 are made with changes in the reflectivity. Similar diffraction patterns can be made with the change of refractive index or other optical properties. Chemical reaction in certain pixels can change the refractive index. Since the phase of the diffracted and reflected lights is controlled by the film thickness and refractive index, the chemical reaction can form different diffraction patterns.

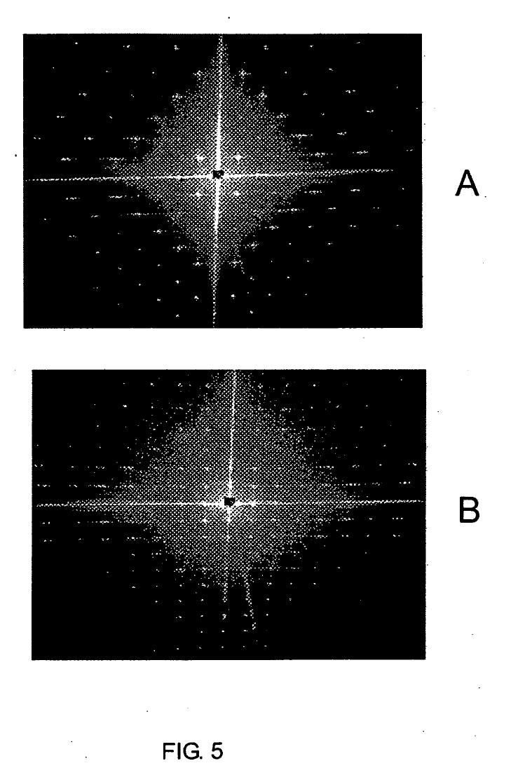

FIG. 5 shows (FIG. 5A) an exemplary diffraction pattern by alternating transparent refractive pixels (PMMA refractive index n=1.4˜1.5), and (FIG. 5B) an exemplary diffraction pattern obtained when the refractive index of alternating pixels becomes close to n=1.

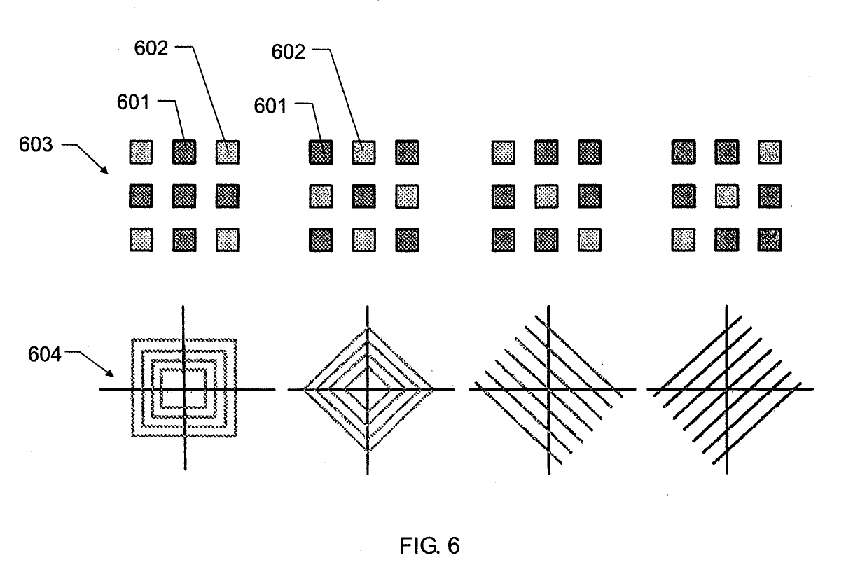

The reflection and diffraction patterns by an array of sensor elements as shown in FIGS. 4 and 5 generate the images of both the chemically reacted and un-reacted sensor elements. The general image patterns of the above samples are diamond and square shape as appears in FIGS. 4 and 5, or linearly arranged lines. In order for a sensor array to respond to foreign chemicals or bioelements, each detector element has a reflective coating that is vulnerable to and easily damaged by a specific chemical material. If an array is designed to sense a specific chemical, the selected elements of the array (indicated as a “lost pixel” 604 in FIG. 6) are coated with a material that reacts specifically with the chemical. On the other hand, the active pixels 602 etc. on the same array are coated with a different material that is reactive to a different chemical. The reaction pattern of pixels (the lost pixels in FIG. 6) in an array will develop a specific pattern of image. In FIG. 6, four different types of arrays, 603 etc., are illustrated. The lost pixels are initially coated with a material that is reactive with a chemical, and then exposed to an environment where the chemical is contaminated. In such a case, the chemically reactive or sensitive elements lose their reflectivity due to chemical reaction. The reflective and diffractive image pattern signifies whether a chemical exists. Other chemicals cannot be probed by this image pattern but other arrays which are specifically designed for other chemicals will perform the same probing method with different image patterns. The image patterns of each array after exposure shows specific image patterns 604 etc. as a chemical signature.

The element size is as small as a few hundred nanometers to a few μm. With this size of an element, an array of 500 by 500 elements (total 250,000) can be built within the area of 1 mm by 1 mm. If for example one chemical is represented by a formation of an array of 3×3, there will be more than 25,000 chemical arrays within the area of 1 mm×1 mm. If a 3×3 array does not give sufficient numbers of combinations for 25,000 chemicals, then a 3×3 array cannot represent all of the chemicals. Accordingly, to increase the combinatory power, by binding (for example) ten arrays of 3×3 (which will encompass 90 elements) it is possible to represent the chemicals. Such a representation by 90 elements per a chemical will still give probing capability of 2,500 chemicals simultaneously.

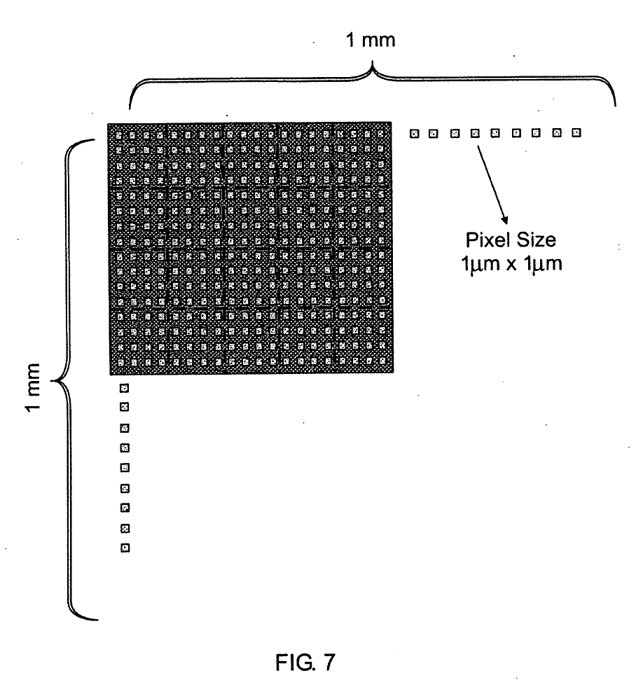

A sensor footprint of 1 mm×1 mm can hold 250,000 elements of 1 μm×1 μm size. If we use an array of 10×10 elements per a chemical, there will be sufficient combinations to represent numerous chemicals. In such a case, as shown in FIG. 7, a sensor footprint of 1 mm×1 mm can detect 2,500 chemicals simultaneously.

A method can also be provided to retrieve information from micro-pixel-structures, such as those of the detector arrays described here. Diffraction methods in accordance with the invention convert the microscopic chemical reaction phenomena into a macroscopic optical event, i.e. the diffraction pattern on a screen or other display surface. In some embodiments, the display may be positioned and arranged such that it can be observed with naked eye without the need for additional complex micro-electronics. Alternatively, the diffraction image may be photographed or otherwise recorded for later analysis.

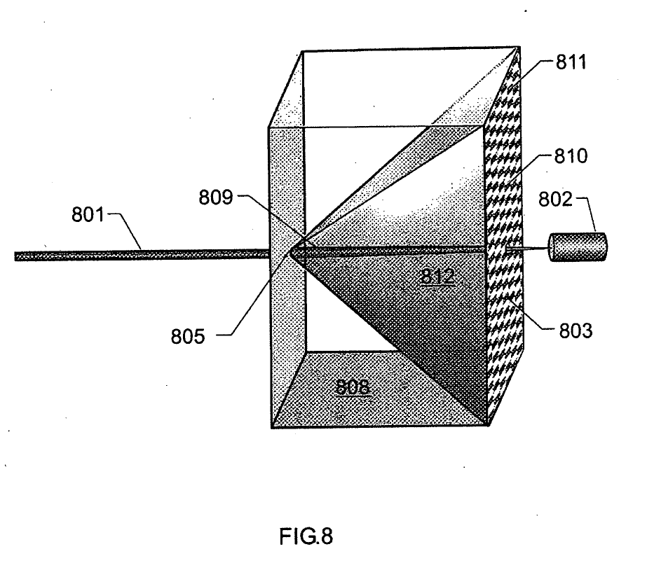

Further structures, such as projector lens, can be used in order to improve the visibility of a change of diffraction patterns. Or, instead of a screen, the actual device can feed diffraction patterns onto a CCD array, and the system can electronically count the different images to identify any chemical contaminants. Such a CCD counter is already available in the market. FIG. 8 shows a rough sketch of an exemplary device structure that consists of a probe 801 illuminated by a laser 802 and a CCD counter 803 of diffraction pattern images 811 to identify the chemicals. The tip 805 of the probe stick 801 has an area of 1 mm×1 mm where 250,000 elements of 1 μm×1 μm reflective (chemically sensitive) patches are provided. These 250,000 elements are organized by groupings of ten to a hundred. Each group will have a specially designed reflective coating that reacts only with a specific chemical. Therefore, probe stick 801 will have the sensing capability of 2,500 to 25,000 kinds of chemicals as long as that many chemically reactive/reflective coatings are available.

Probe tip 805 is first dipped into a batch of chemical or otherwise exposed to an area that may be chemically contaminated. After being withdrawn, the probe tip 805 is cleaned by de-ionized water and inserted into test box 808 where a laser beam 809 illuminates the tip 805 to create diffraction patterns. The diffracted beam 812 after illumination merges onto the CCD plane 810 where diffraction patterns 810 will indicate, group by group, specific chemical(s). Preferably, the CCD readings of affected groups will be interpreted electronically to output an identification of what each detected chemical is by name, rather than by showing spectral signatures. An affected set of detectors means that the designated chemical exists. Otherwise (within the tolerance of the detectors), no chemical exists. Thus, the CCD display can show a chemical in a binary on and off mode. The array is physically capable of also quantifying the detected chemicals, but good methods for gathering such information requires further study. Instead of probe stick 801, a flat patch containing sensor pixels can be used as well (among other embodiments that will be apparent to those of skill in the art).

In summary, it can be seen that the invention can be used to provide an integrated universal chemical detector in a micro-optical chip in which chemical/bio-sensitive micro/nano-pixels are aligned in a special way to create many different diffraction patterns according to the chemical/bio reactions. This method can integrate tens, hundreds or more of chemical detectors in a tiny size optical chip. In addition, it does not require complex electronic device or micro-electronic circuit at all. A simple laser pointer or semi-coherent light and blank screen with aperture can detect many chemical species with one integrated universal chemical detector chip.

It is apparent that the invention meets the objectives set forth above and provides a number of advantages in terms of small size, resolution and effectiveness, over the prior art. Although the invention has been described in detail, it should be understood that various changes, substitutions, and alterations may be readily ascertainable by those skilled in the art and may be made herein without departing from the spirit and scope of the present invention as defined by the following claims.

We claim:

1. An apparatus for detecting one or more of a plurality of species or classes of chemical or bioelement agents, comprising:
(a) an array comprising a plurality of sets of agent indicators, each such set comprising elements that change an optical characteristic in a determined manner upon exposure to a specific agent;
(b) a light beam for illuminating said array and creating one or more diffraction patterns corresponding to the patterns of one or more of said sets of elements of said array that have undergone a change in optical characteristic as a result of said exposure; and
(c) an area for receiving said one or more diffraction patterns.

2. The apparatus of claim 1, wherein said optical characteristics comprise one or more characteristics selected from the group comprising change in color, change in reflectivity, change in transmittivity and change in refractive index.

3. The apparatus of claim 1, wherein said area for receiving said one or more diffraction patterns comprises a visually perceptible display area.

4. The apparatus of claim 1, wherein said area for receiving said one or more diffraction patterns comprises a CCD detector, and wherein said apparatus further comprises a classification program for said diffraction patterns to identify diffraction patterns corresponding to specific ones of said sets or elements, and logic to correlate said classifications with an identification of any agents detected.

5. An apparatus for detecting one or more of a plurality of species or classes of chemical or bioelement agents, comprising:
(a) a probe;
(b) a detector array disposed on the distal end of said probe, said detector array comprising a plurality of sets of agent indicators, each such set comprising elements that change an optical characteristic in a determined manner upon exposure to a specific agent;
(c) a display surface having an aperture for passing a light beam;
(d) a light source for said light beam;
(e) a frame for receiving said probe and positioning it such that said detector array faces said aperture in said display surface; and
(f) a CCD counter coupled to said display.

6. The apparatus of claim of claim 6, further comprising a computer programmed to output an identification of one or more agents to which said detector array has been exposed, computed based on the output of said CCD counter.

7. A method for detecting one or more of a plurality of species or classes of chemical or bioelement agents, comprising:
(a) exposing a detector array disposed on the distal end of a probe to a source of potential agents, said detector array comprising a plurality of sets of agent indicators, each such set comprising elements that change an optical characteristic in a determined manner upon exposure to a specific agent;
(b) positioning said probe in a frame such that said detector array positioned such that it faces an illuminating aperture in a display screen;
(c) directing a light source through said aperture so as to illuminate said detector array; and
(d) displaying a diffraction pattern of light reflected from said detector array on said screen.

8. The method of claim 8, further comprising visually examining said display, classifying said diffraction pattern and identifying said one or more agents.

9. The method of claim 8, further comprising recording an image of said display for later classifying said diffraction pattern and identifying said one or more agents.

10. The method of claim 8, further comprising electronically analyzing the image of said display, classifying said diffraction pattern and identifying said one or more agents.
